(19) United States
(12) Patent Application Publication
(10) Pub. No.: US 2026/0330796 A1
(43) Pub. Date: Oct. 22, 2026

(54) OBJECT DETECTION DEVICE, OBJECT DETECTION METHOD, AND STORAGE MEDIUM

(71) Applicant: HONDA MOTOR CO., LTD., Tokyo (JP)

(72) Inventors: Riku Inoue, Wako-shi (JP); Masamitsu Tsuchiya, Wako-shi (JP)

(21) Appl. No.: 19/529,176

(22) Filed: Feb. 4, 2026

(30) Foreign Application Priority Data
Feb. 10, 2025 (JP) 2025-019859

(51) Int. Cl. G06V 10/25; G06F 16/583

(52) U.S. Cl. CPC G06V 10/25; G06F 16/583; G06V 2201/07

(57) ABSTRACT

An object detection device includes a storage medium having computer-readable instructions stored therein, and a processor connected to the storage medium. The processor executes the computer-readable instructions, to thereby convert an input image into a high-dimensional vector, determine whether a query set in the input image is an object on the basis of the high-dimensional vector, detect a region of the object on the basis of the high-dimensional vector, detect a type of the object on the basis of the high-dimensional vector, and detect an object by processing the high-dimensional vector. The processor detects the object on the basis of a result of detection of the region and the type based on a high-dimensional vector obtained by processing the high-dimensional vector multiple times and a result of the determination based on a high-dimensional vector obtained by processing the high-dimensional vector earlier than the multiple times.

### CROSS-REFERENCE TO RELATED APPLICATION

This application is based upon and claims the benefit of priority from Japanese Patent Application No. 2025-019859, filed Feb. 10, 2025, the entire contents of which is incorporated herein by reference.

### BACKGROUND

### Field of the Invention

The present invention relates to an object detection device, an object detection method, and a storage medium.

### Description of Related Art

In recent years, efforts to provide access to sustainable transportation systems that take into account the vulnerable among traffic participants have become active. In order to achieve this, concentration has been focused on research and development to further improve traffic safety and convenience through research and development related to automated driving technology and preventive safety technology.

Incidentally, in automated driving technology and preventive safety technology, research has been conventionally conducted on open world object detection (OWOD) which is capable of detecting not only known objects but also unknown objects from images. For example, Orr Zohar, Kuan-Chieh Wang, and Serena Yeung. Prob: Probabilistic objectness for open world object detection. In Proceedings of the IEEE/CVF Conference on Computer Vision and Pattern Recognition, pages 11444-11453, 2023 discloses a technique of probabilistically detecting whether an object is present without using pseudo labels for unknown objects. Zhuyu Yao, Jiangbo Ai, Boxun Li, and Chi Zhang. Efficient detr: improving end-to-end object detector with dense prior. arXiv preprint arXiv:2104.01318, 2021 discloses a technique of performing object detection by converting an image into a feature map using a convolutional neural network (CNN) and applying a transformer to the feature map.

More specifically, the technique disclosed in Orr Zohar, Kuan-Chieh Wang, and Serena Yeung. Prob: Probabilistic objectness for open world object detection. In Proceedings of the IEEE/CVF Conference on Computer Vision and Pattern Recognition, pages 11444-11453, 2023 involves allowing a transformer decoder to simultaneously learn to estimate objectness (whether it is an object) and to estimate a class. The technique disclosed in Non-Patent Document 2 involves inputting object queries for object detection and class classification to a transformer decoder and performing learning of the object queries during learning.

However, in the technique disclosed in Non-Patent Document 1, conflict arises between learning for objectness estimation and learning for class estimation. Further, in the technique disclosed in Non-Patent Document 2, the object query is not configured to capture the features of objects in the initial layer of the decoder. As a result, these conventional techniques have room for improvement in the accuracy of object detection.

### SUMMARY

The present invention was contrived in view of such circumstances, and one object thereof is to provide an object detection device, an object detection method, and a storage medium that, in object detection targeting both known objects and unknown objects, make it possible to capture the features of objects from the initial layer of a transformer decoder while preventing conflict between learning for objectness estimation and learning for class estimation from arising, thereby improving the accuracy of object detection. This will ultimately contribute to the development of a sustainable transportation system.

The following configurations are adopted in an object detection device, an object detection method, and a storage medium according to this invention.
(1) According to an aspect of this invention, there is provided an object detection device including: a storage medium having computer-readable instructions stored therein; and a processor connected to the storage medium, wherein the processor executes the computer-readable instructions, to thereby convert an input image into a high-dimensional vector, determine whether a query set in the input image is an object on the basis of the high-dimensional vector, detect a region of the object on the basis of the high-dimensional vector, detect a type of the object on the basis of the high-dimensional vector, and detect an object by processing the high-dimensional vector, and the processor detects the object on the basis of a result of detection of the region and the type based on a high-dimensional vector obtained by processing the high-dimensional vector multiple times and a result of the determination based on a high-dimensional vector obtained by processing the high-dimensional vector earlier than the multiple times.
(2) In the aspect of the above (1), functional units for the conversion of the high-dimensional vector, the determination, the detection of the region, and the detection of the type are obtained by training a deep learning model having a self-attention mechanism.
(3) In the aspect of the above (2), the deep learning model is a transformer model, and the processor detects the object on the basis of a result of detection of the region and the type based on a high-dimensional vector obtained by processing the high-dimensional vector multiple times in each layer of a decoder of the transformer model, and a result of the determination based on a high-dimensional vector obtained by processing the high-dimensional vector earlier than the multiple times in each layer of the decoder.
(4) In the aspect of the above (1), the processor calculates a first probability value indicating whether the query is an object, the processor calculates a second probability value indicating a type of the query, and the processor detects the object on the basis of the first probability value and the second probability value.
(5) In the aspect of the above (1), the query includes a first query selected from a plurality of the high-dimensional vectors and an initialized second query, and the processor detects the object for each of the first query and the second query.
(6) In the aspect of the above (5), the first query is selected to be distributed over known objects in the input image, and the second query is set to be distributed across the entire input image and is trained to be distributed over both known objects and unknown objects.
(7) According to another aspect of this invention, there is provided an object detection method including causing a computer to: convert an input image into a high-dimensional vector; determine whether a query set in the input image is an object on the basis of the high-dimensional vector; detect a region of the object on the basis of the high-dimensional vector; detect a type of the object on the basis of the high-dimensional vector; detect an object by processing the high-dimensional vector; and detect the object on the basis of a result of detection of the region of the object and the type of the object based on a high-dimensional vector obtained by processing the high-dimensional vector multiple times, and a result of determination of whether it is the object based on a high-dimensional vector obtained by processing the high-dimensional vector earlier than the multiple times.
(8) According to another aspect of this invention, there is provided a computer readable non-transitory storage medium having a program stored therein, the program causing a computer to: convert an input image into a high-dimensional vector; determine whether a query set in the input image is an object on the basis of the high-dimensional vector; detect a region of the object on the basis of the high-dimensional vector; detect a type of the object on the basis of the high-dimensional vector; detect an object by processing the high-dimensional vector; and detect the object on the basis of a result of detection of the region of the object and the type of the object based on a high-dimensional vector obtained by processing the high-dimensional vector multiple times, and a result of determination of whether it is the object based on a high-dimensional vector obtained by processing the high-dimensional vector earlier than the multiple times.

According to the aspects of (1) to (8), in object detection targeting both known objects and unknown objects, it is possible to capture the features of objects from the initial layer of a transformer decoder while preventing conflict between learning for objectness estimation and learning for class estimation from arising, thereby improving the accuracy of object detection. This will ultimately contribute to the development of a sustainable transportation system.

### BRIEF DESCRIPTION OF THE DRAWINGS

FIG. 1 is a diagram illustrating an example of a system including an object detection device according to an embodiment of the present invention.

FIG. 2 is a diagram illustrating an example of a configuration of training data.

FIG. 3 is a diagram illustrating an example of a configuration of a machine learning model in a learning stage.

FIG. 4 is a diagram illustrating object queries which are generated by a query generation unit.

FIG. 5 is a diagram illustrating a process which is executed by a decoder unit.

FIG. 6 is a diagram illustrating an example of a configuration of a machine learning model in an inference stage.

FIG. 7 is a diagram illustrating the effects of the method of the present invention.

FIG. 8 is a flowchart illustrating an example of a flow of training the machine learning model.

FIG. 9 is a flowchart illustrating an example of a flow of inference using the machine learning model.

### DESCRIPTION OF EMBODIMENTS

Hereinafter, an embodiment of an object detection device, an object detection method, and a storage medium of the present invention will be described with reference to the accompanying drawings.

### [Overall Configuration]

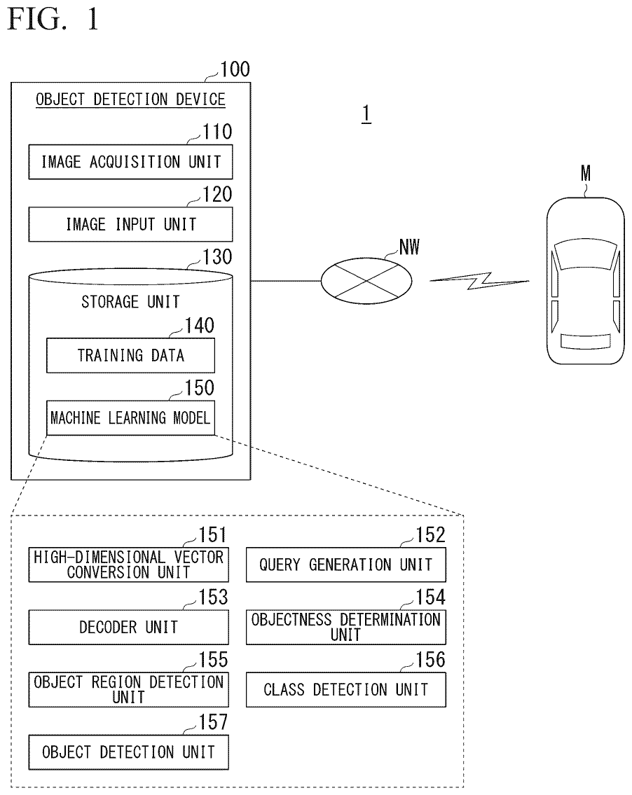

FIG. 1 is a diagram illustrating an example of a system 1 including an object detection device 100 according to an embodiment of the present invention. As shown in FIG. 1, the system 1 includes a vehicle M and the object detection device 100. In FIG. 1, as an example, the vehicle M and the object detection device 100 are configured as separate units, but the object detection device 100 may be mounted in the vehicle M. In addition, the cooperation between the object detection device 100 and the vehicle M is merely an example, and the object detection device 100 may be used as a standalone unit without cooperation with the vehicle M. For example, the object detection device 100 may be implemented as a Web server, or may be implemented as an application program on a user's terminal device (for example, a personal computer or a smartphone).

The vehicle M is, for example, a hybrid automobile or an electric automobile, and includes, for example, a camera that captures images of the exterior of the vehicle M. While traveling, the vehicle M transmits outside-vehicle image captured by a camera to the object detection device 100 through a network NW such as cellular network, a Wi-Fi network, or the Internet.

The object detection device 100 receives an image transmitted from the vehicle M and detects an object captured in the received image. The object detection device 100 includes, for example, an image acquisition unit 110, an image input unit 120, and a storage unit 130. Components such as the image acquisition unit 110 and the image input unit 120 are realized, for example, by a hardware processor such as a central processing unit (CPU) executing a program (software). Some or all of these components may be realized by hardware (a circuit unit; including circuitry) such as a large scale integration (LSI), an application specific integrated circuit (ASIC), a field-programmable gate array (FPGA), or a graphics processing unit (GPU), and may be realized by software and hardware in cooperation. The program may be stored in a storage device such as a hard disk drive (HDD) or a flash memory (a storage device including a non-transitory storage medium) in advance, may be stored in a detachable storage medium such as a DVD or a CD-ROM (non-transitory storage medium), or may be installed by the storage medium being installed in a drive device.

The storage unit 130 is, for example, an HDD, a flash memory, a random access memory (RAM), or the like. The storage unit 130 stores, for example, training data 140 and a machine learning model 150. Meanwhile, for convenience of description, the storage unit 130 stores the training data 140, but the present invention is not limited to such a configuration, and as will be described later, only the machine learning model 150 trained on the basis of the training data 140 may be stored.

The image acquisition unit 110 acquires an image from the vehicle M through the network NW, and the image input unit 120 detects an object captured in the acquired image by inputting the acquired image into the trained machine learning model 150. The object detection device 100 may transmit information relating to the detected object to the vehicle M through the network NW. Thereafter, the vehicle M may provide, for example, driving assistance (such as, for example, displaying the detected object on a navigation device of the vehicle M or outputting alert information as audio) to an occupant of the vehicle M on the basis of information relating to the detected object, or may perform automated driving (such as, for example, generating a target trajectory to avoid the detected object). The object detection device 100 may be equipped with such a driving assistance function and an automated driving function.

The machine learning model 150 includes, as its functional units, for example, a high-dimensional vector conversion unit 151, a query generation unit 152, a decoder unit 153, an objectness determination unit 154, an object region detection unit 155, a class detection unit 156, and an object detection unit 157. These functional units are also realized, for example, by a hardware processor such as a CPU executing a program. In the present embodiment, the machine learning model 150 is an object detection method using a transformer model (more specifically, end-to-end object detection with transformers (DETR)) with two improvements, the details of which will be described later.

### [Training Data]

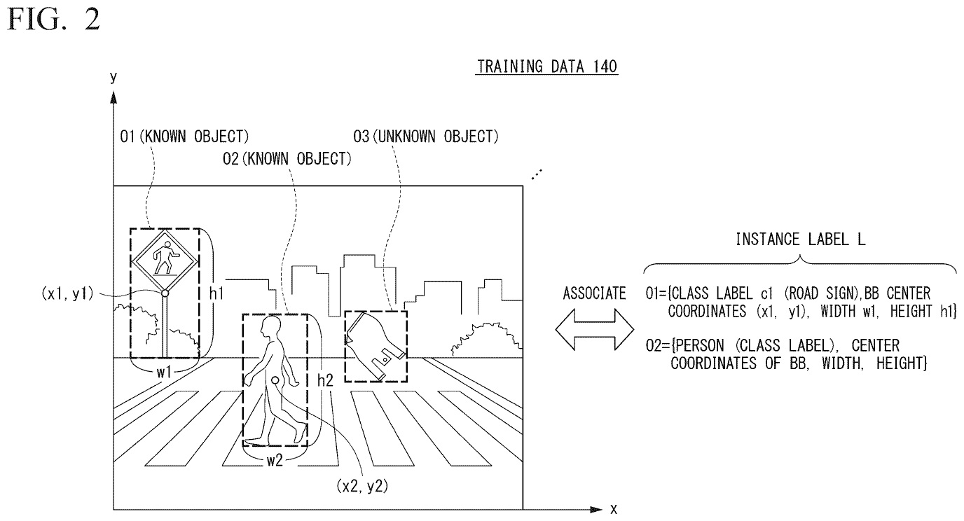

FIG. 2 is a diagram illustrating an example of a configuration of the training data 140. The training data 140 is a data set composed of a plurality of images IM including both known objects and unknown objects to be detected. For example, in FIG. 2, the image IM includes a known object O1 which is a road sign, a known object O2 which is a person, and an unknown object O3 which is a plastic bag. In the present embodiment, for a known object, the class label c indicating the object, the central coordinates (x, y) of the bounding box (hereinafter sometimes referred to simply BB) surrounding the object, the width w, and the height h are associated in advance with each other. In another aspect, the bounding box can also be expressed by a combination of the minimum value x_min and maximum value x_max on the x coordinate and the minimum value y_min and maximum value y_max on the y coordinate, and thus (x_min, x_max, y_min, y_max) may be associated with a known object.

Therefore, in the case of the images IM in FIG. 2, the class label c1 indicating a road sign, the central coordinates (x1, y1) of the BB, the width w1, and the height h1 are associated with the known object O1, and the class label c2 indicating a person, the central coordinates (x2, y2) of the BB, the width w2, and the height h2 are associated with the known object O2. The combination of these images IM with the class label c, the central coordinates (x, y) of the BB, the width w, and the height h (hereinafter referred to as the instance label L) associated with a known object included in the image IM constitutes the training data 140.

### [Training of Machine Learning Model]

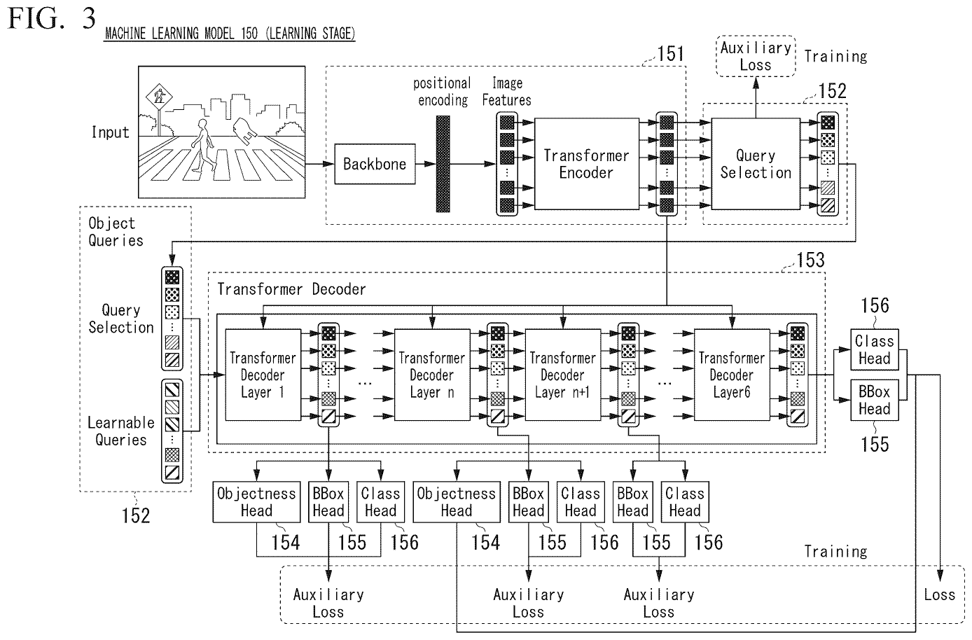

FIG. 3 is a diagram illustrating an example of a configuration of the machine learning model 150 in a learning stage. Hereinafter, training of the machine learning model 150 will be described with reference to FIG. 3. First, as shown in the upper left of FIG. 3, the high-dimensional vector conversion unit 151 inputs the image IM included in the training data 140 into a Backbone network. The Backbone network includes a convolutional neural network (CNN), and performs convolution using the CNN on an input image IM to convert it into a d-dimensional feature map (feature amount) with reduced dimensions.

Next, the high-dimensional vector conversion unit 151 performs positional encoding on the feature map output from the Backbone network. Here, positional encoding is a process for associating the feature map with position of the original input image IM. By performing positional encoding, an object query to be described later can specify a position on the input image IM from the feature map.

Next, the high-dimensional vector conversion unit 151 inputs the feature map that has undergone positional encoding to a transformer encoder. Here, the transformer encoder uses a self-attention mechanism and a feed forward layer to output a plurality of queries (hereinafter sometimes referred to as intermediate object features) from the feature map output from the CNN. Here, the query represents a vector (high-dimensional vector) indicating which part of the image IM should be focused on (which part is the object). In the machine learning model 150, the process from an input to the Backbone network to an output by the transformer encoder is a process executed by the high-dimensional vector conversion unit 151.

Next, the query generation unit 152 performs query selection on the queries output by the transformer encoder. Here, query selection is a process of selecting queries which are highly likely to represent objects in the image IM. As described above, the training data 140 includes instance labels L for known objects. Therefore, by learning query selection using the training data 140 relating to known objects, it is possible to select queries that focus on known objects from the image IM. More specifically, query selection is implemented by learning parameters of a deep neural network (DNN) model that represents query selection for each piece of data of known objects. The learning of query selection is executed simultaneously with the learning of the objectness determination unit 154, the object region detection unit 155, and the class detection unit 156, which will be described later.

Further, the query generation unit 152 generates an initialized learnable query. The learnable query is a query set mainly for the purpose of extracting unknown objects from the image IM. The query generation unit 152 generates an object query by combining the query selected by the query selection and the initialized learnable query. That is, in the technique disclosed in Non-Patent Document 2, the object query is not configured to capture the features of the object in the initial layer of the decoder, whereas in the present embodiment, the object query includes queries that focus on known objects selected by query selection, and is thus configured to capture the features of the object from the initial layer of the decoder to be described below.

The object query generated by the query generation unit 152 is input to the transformer decoder by the decoder unit 153. Here, the transformer decoder uses a self-attention mechanism, a multi-head attention mechanism, and a feed forward layer to combine intermediate object features with the object query and finally detect an object. Hereinafter, for convenience, it is assumed that the number of object queries is N. N is a hyperparameter which is set in advance.

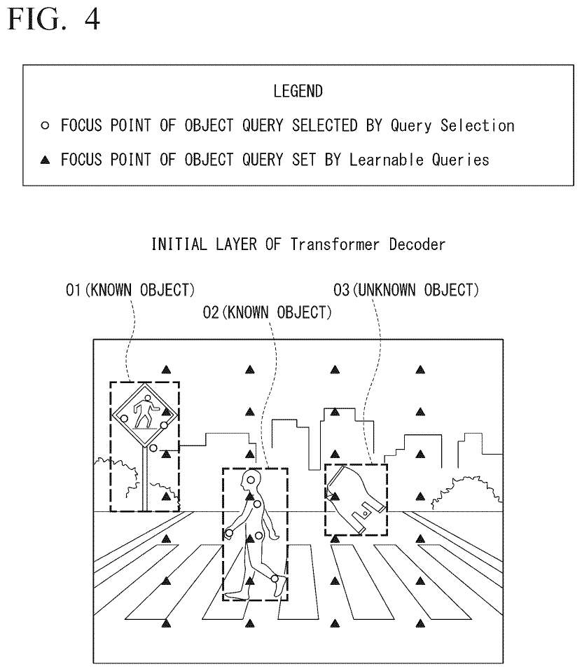

FIG. 4 is a diagram illustrating object queries generated by the query generation unit 152. FIG. 4 shows object queries generated by the query generation unit 152 at a point in time when the object queries are input to the initial layer of the transformer decoder. In FIG. 4, object queries indicated by black circles represent queries selected by query selection, and object queries indicated by black triangles represent initialized learnable queries.

As shown in FIG. 4, the queries selected by query selection tend to be distributed (focused) on known objects (that is, an object O1 and an object O2) in the image IM at a point in time of the initial layer input to the transformer decoder, while the initialized learnable queries are set to be distributed (focused) on the entire image IM regardless of whether the objects are known or unknown in the image IM. Meanwhile, in FIG. 4, the initialized learnable queries are set at fixed intervals on the image IM, but the present invention is not limited to such a configuration and may be initialized using any method, such as being set randomly.

The decoder unit 153 inputs the object query generated by the query generation unit 152 to the transformer decoder having a plurality of transformer decoder layers. The initial layer of the transformer decoder inputs the intermediate object features output by the transformer encoder and the N object queries generated by the query generation unit 152, combines them using a multi-head attention mechanism, and outputs N object queries obtained by more precisely capturing objects (regardless of whether they are known or unknown) in the image IM.

Similarly, the subsequent layer of the transformer decoder inputs the intermediate object features output by the transformer encoder and the N object queries output by the layer immediately preceding the transformer decoder, combines them using a multi-head attention mechanism, and outputs N object queries obtained by more precisely capturing objects (regardless of whether they are known or unknown) in the image IM. By repeating such a process, the decoder unit 153 finally outputs N object queries from the final layer of the transformer decoder.

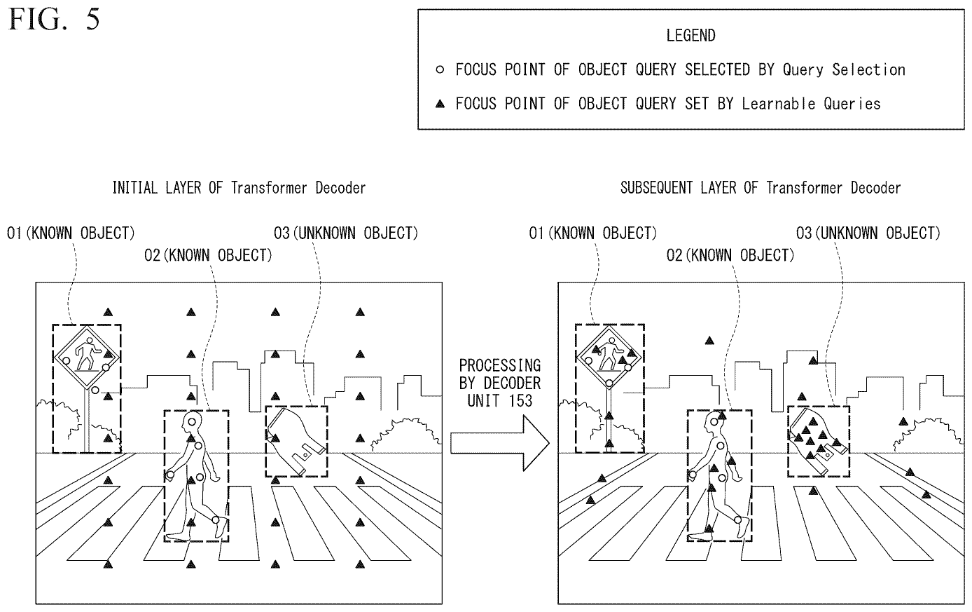

FIG. 5 is a diagram illustrating a process which is executed by the decoder unit 153. The left part of FIG. 5 shows the same screen as in FIG. 4, and the right part of FIG. 5 shows object queries obtained after processing by the decoder unit 153 (that is, processing by each transformer decoder layer) has been executed. As shown in FIG. 5, the initialized learnable query did not capture any objects in the initial layer, but as a result of processing by the decoder unit 153, it captures both known objects (that is, an object O1 and an object O2) and an unknown object (that is, an object O3). In this way, according to the present embodiment, the object query includes a query selected by query selection and an initialized learnable query, so that known objects are captured from the initial layer, while processing by the decoder unit 153 allows both known and unknown objects to be captured in the subsequent layer.

The objectness determination unit 154 (Objectness Head) probabilistically determines whether each object query output by the transformer decoder layer is an object (objectness) (hereinafter, the output value by the objectness determination unit 154 may be referred to as p(o|q)). More specifically, in the present embodiment, the probability value p(o|q) is modeled as a multivariate Gaussian distribution in the query embedding space, and the objectness determination unit 154 uses the Mahalanobis distance to calculate the probability value p(o|q)=f_{obj}(q) on the basis of the following Equation (1).

$$\begin{matrix}[ Math . 1 ] & \\ \begin{matrix}{f}_{obj} ( q ) = exp ( - {( q - μ )}^{T} {\sum }^{- 1} ( q - μ ) ) \\ = exp ( {{d}_{M} ( q )}^{2} )\end{matrix} & ( 1 )\end{matrix}$$

In Equation (1), the symbol μ represents the mean value of the multivariate Gaussian distribution, the symbol Σ represents the variance-covariance matrix of the multivariate Gaussian distribution, the symbol q represents a d-dimensional vector which is each object query, and the symbol d_{M} represents the Mahalanobis distance in the query embedding space.

In the learning stage of the objectness determination unit 154, in order to estimate (optimize) the mean value μ and variance-covariance matrix Σ of the multivariate Gaussian distribution, the sum of squared Mahalanobis distances shown by the following Equation (2) is defined as the error function L_{obj} of objectness.

$$\begin{matrix}[ Math . 2 ] & \\ {ℒ}_{o b j} = {\sum }_{i ∈ Z} {{d}_{M} ( {q}_{i} )}^{2} & ( 2 )\end{matrix}$$

In Equation (2), the symbol Z represents the set of queries qᵢ matched with known objects in the training data 140. By learning to reduce the error function L_{obj} (that is, optimize the likelihood), p(o|q)=f_{obj}(q) representing the objectness of each object query is learned.

The object region detection unit 155 (BBox Head) detects the position of the object on the image IM as a bounding box for each object query output by the transformer decoder layer. More specifically, the object region detection unit 155 is a deep neural network (DNN) that outputs, for each object query, position information (central coordinates, width, height) of the bounding box corresponding to the object query. The object region detection unit 155 is obtained by reducing the Li loss and the gIoU (generalized Intersection over Union) loss L_{bb} for bounding box learning.

In a case where each object query output by the transformer decoder layer is assumed to be an object, the class detection unit 156 (Class Head) probabilistically detects the class of the object (hereinafter, the output value by the class detection unit 156 may be referred to as p(c|o, q)). More specifically, in a case where each object query is assumed to be an object, the class detection unit 156 is a DNN that outputs the class (type) of the object as a probability value. The class detection unit 156 is obtained by reducing the Sigmoid focal loss L_{cls} for class detection learning. The class detection unit 156 is trained to output each class for known objects, while the class detection unit is trained to output the unknown class (unknown) for unknown objects.

In this way, each transformer decoder layer outputs N object queries, and the objectness determination unit 154, the object region detection unit 155, and the class detection unit 156 each use each object query q as an input, and output a probability value p(o|q), position information of a bounding box, and a probability value p(c|o, q). In the learning stage of the machine learning model 150, learning is performed to ultimately reduce the error function L expressed by the following Equation (3) using the error function L_{obj} of the objectness determination unit 154, the error function L_{bb} of the object region detection unit 155, and the error function Lis of the class detection unit 156.

[Math. 3]

L=L_{bb}+L_{cls}+L_{obj} (3)

As shown in Equation (3), the error function L is expressed as the sum of the error function L_{obj}, the error function L_{bb}, and the error function L_{cls}. That is, in the learning stage, objectness determination, the bounding box determination, and class determination are simultaneously learned. However, there are cases where conflicts arise between the learning of objectness determination and the learning of class determination. This is because the learning of objectness determination tends to proceed in a direction in which the feature amounts of the object are separated from the background and integrated (thereby recognizing a single object), whereas the learning of class determination tends to proceed in a direction in which the feature amounts of the object are separated from each other (thereby identifying different objects).

In view of such circumstances, in the present embodiment, among the transformer decoder layers, the learning of objectness determination is stopped at an early stage (for example, the second layer), and in the subsequent layers, only learning of bounding box determination and learning of class determination are performed. For example, in the case of FIG. 3, the number of transformer decoder layers is six, and for the layers from the first layer to the (n−1)-th (2<n<6) layer and the sixth layer, learning is performed to reduce the error function L expressed by Equation (3), whereas the layers from the nth layer to the fifth layer, learning is performed to reduce the error function L′=L_{bb}+L_{cls}. This makes it possible to train the objectness determination unit 154, the object region detection unit 155, and the class detection unit 156 while suppressing conflict between the learning of objectness determination and the learning of class determination. Meanwhile, the six layers of the transformer decoder in FIG. 3 are merely an example, and any positive integer number of layers may be set.

### [Inference Using Machine Learning Model]

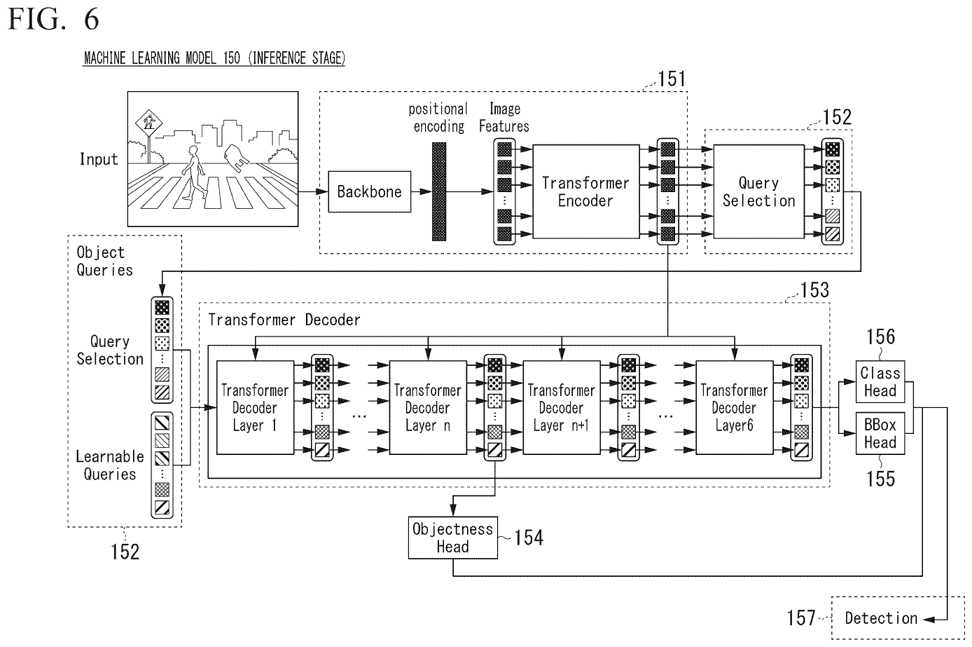

FIG. 6 is a diagram illustrating an example of a configuration of the machine learning model 150 in an inference stage. The machine learning model 150 shown in FIG. 6 is a trained model obtained when the training of the machine learning model 150 shown in FIG. 5 is completed. The initialized learnable query in FIG. 5 becomes the trained query in FIG. 6. The machine learning model 150 in the inference stage accepts an input of an image which is a target for object estimation, and sequentially executes the processes of the high-dimensional vector conversion unit 151, the query generation unit 152, and the decoder unit 153.

As described above, the learning of objectness determination is stopped at the stage of the initial layer in the transformer decoder layer. Therefore, in the case of FIG. 6, in the machine learning model 150 at the inference stage, the objectness determination unit 154 accepts the object query q of the nth layer as an input, and outputs the probability value p(o|q) of objectness. On the other hand, the object region detection unit 155 accepts the object query q of the sixth layer as an input, and outputs the position information of the bounding box. Similarly, the class detection unit 156 accepts the object query q of the sixth layer as an input, and outputs the probability value p(c|o, q) of the class.

In the inference stage, the object detection unit 157 detects an object from the input image to be estimated on the basis of the probability value p(o|q) output by the objectness determination unit 154, the position information of the bounding box output by the object region detection unit 155, and the probability value p(c|o, q) output by the class detection unit 156.

More specifically, the object detection unit 157 first calculates the estimation value p(c|q)=p(c|o, q)×p(o|q) of the final class for each object query q. Next, the object detection unit 157 narrows down object queries q in which the estimation value p(c|q) of the final class is equal to or greater than a threshold among the object queries q, and detects the narrow-down object queries q as objects. Alternatively, the object detection unit 157 may narrow down object queries q in which the estimation value p(c|q) of the final class is within a predetermined top number.

When an object is detected by the object detection unit 157, the object detection device 100 may provide information relating to the detected object to the vehicle M, and may be used for driving assistance or automated driving. For example, the object detection device 100 may superimpose class information and position information of the bounding box on the input image for the object query q detected as an object, and may output the superimposed image to, for example, a navigation device of the vehicle M. In addition, the vehicle M having an automated driving function may generate a traveling trajectory to avoid the object query q detected as an object.

### Effects of Method of the Present Invention

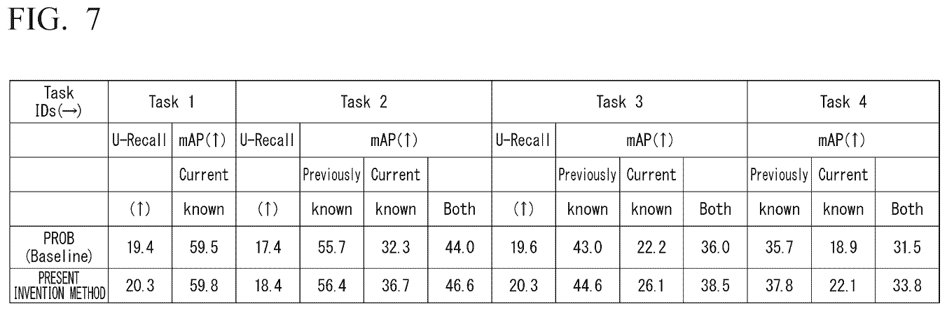

FIG. 7 is a diagram illustrating the effects of the method of the present invention. In the table shown in FIG. 7, the upper part shows the performance of object detection tasks TASK1 to TASK4 using the technique disclosed in Non-Patent Document 1, and the lower part shows the performance of the same tasks using the method of the present invention. As shown in FIG. 7, in each of the object detection tasks TASK1 to TASK4, it has been confirmed that the method of the present invention showed improved performance compared to the technique disclosed in Non-Patent Document 1 in both the detection performance of known objects (mAP) and the detection performance of unknown objects (U-Recall).

### [Flow of Processing]

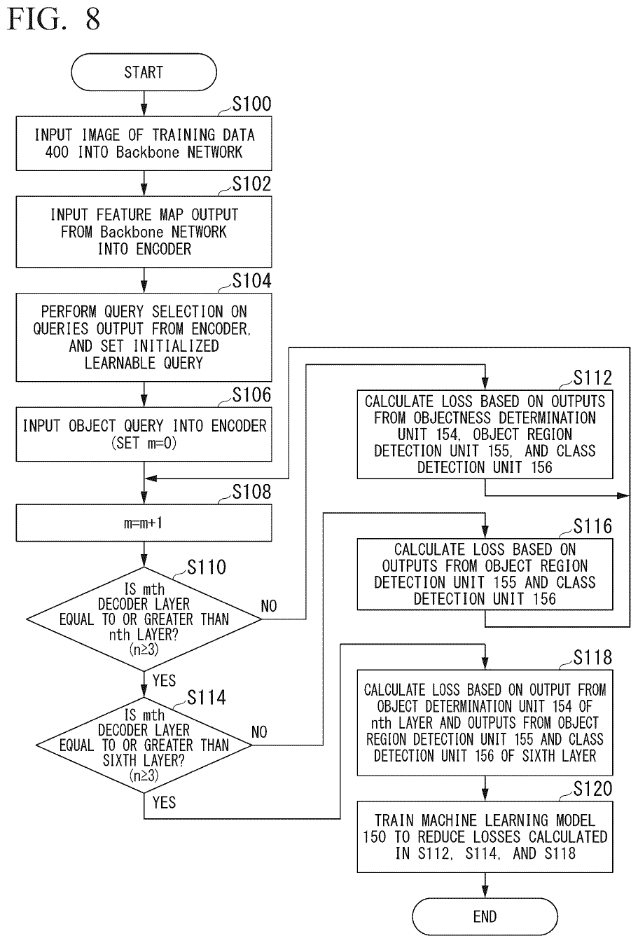

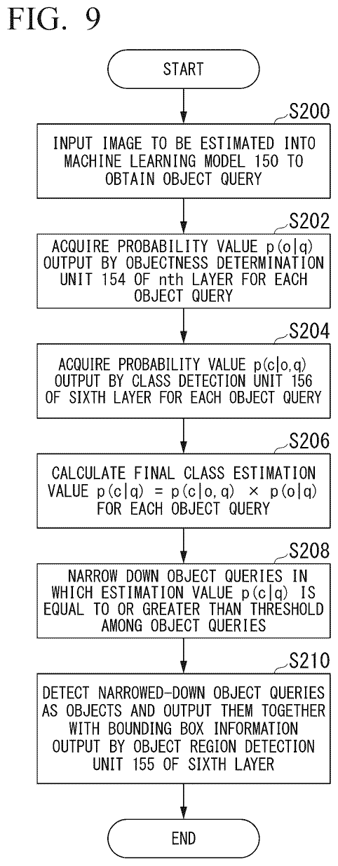

Hereinafter, a flow of processing of training and inference of the machine learning model 150 according to the present invention will be described with reference to FIGS. 8 and 9. FIG. 8 is a flowchart illustrating an example of a flow of training the machine learning model 150. The processing of the flowchart shown in FIG. 8 may be executed manually, or may be automatically executed by a “learning device” which is a computer device that implements the processing of the flowchart.

First, an image of training data 400 is input to the Backbone network of the machine learning model 150 (step S100). Next, the feature map output from the Backbone network is input to the encoder (transformer encoder) (step S102). Next, query selection is performed on the query output from the encoder, and the initialized learnable query is set to as an object query (step S104). Next, the set object query is input to the decoder (simultaneously, m=0 is set) (step S106).

Next, m=m+1 is set (step S108). Next, it is determined whether the mth decoder layer is equal to or greater than the nth layer (for example, n≥3) (step S110). In a case where it is determined that the mth decoder layer is less than the nth layer, the loss L=L_{obj}+L_{bb}+L_{cls} is calculated on the basis of the outputs from the objectness determination unit 154, the object region detection unit 155, and the class detection unit 156 (step S112). On the other hand, in a case where it is determined that the mth decoder layer is equal to or greater than nth layer, it is then determined whether the mth decoder layer is the sixth layer (step S114).

In a case where it is determined that the mth decoder layer is not the sixth layer, the loss L′=L_{bb}+L_{cls} is calculated on the basis of the outputs from the object region detection unit 155 and the class detection unit 156 (step S116). On the other hand, in a case where it is determined that the mth decoder layer is the sixth layer, the loss L=L_{obj}+L_{bb}+L_{cls} is calculated on the basis of the output from the objectness determination unit 154 of the nth layer and the outputs from the object region detection unit 155 and the class detection unit 156 of the sixth layer (step S118). Next, the machine learning model 150 is trained to reduce the losses calculated in steps S112, S114, and S118 (step S120). This completes the processing of the present flowchart.

FIG. 9 is a flowchart illustrating an example of a flow of inference using the machine learning model 150. The machine learning model 150 in FIG. 9 is a trained model that has completed training according to the flowchart shown in FIG. 8, and is used by the object detection device 100.

First, the object detection device 100 inputs an image to be estimated into the machine learning model 150 to acquire an object query (step S200). Next, the object detection device 100 acquires the probability value p(o|q) output by the objectness determination unit 154 of the nth layer for each object query (step S202). Next, the object detection device 100 acquires the probability value p(c|o, q) output by the class detection unit 156 of the sixth layer for each object query (step S204).

Next, the object detection device 100 calculates the estimation value p(c|q)=p(c|o, q)×p(o|q) of the final class for each object query using the object detection unit 157 (step S206). Next, the object detection device 100 uses the object detection unit 157 to narrow down the object queries in which the estimation value p(c|q) is equal to or greater than a threshold among the object queries (step S208). Next, the object detection device 100 detects the narrowed-down object queries as objects, and outputs them together with the bounding box information output by the object region detection unit 155 of the sixth layer (step S210). This completes the processing of the present flowchart.

Meanwhile, in the above embodiment, the components of the machine learning model 150 are described as the high-dimensional vector conversion unit 151, the query generation unit 152, the decoder unit 153, the objectness determination unit 154, the object region detection unit 155, the class detection unit 156, and the object detection unit 157, but these distinctions are made for convenience of description, and the present invention is sufficient insofar as learning for objectness estimation is stopped early and the initialized learnable query is added to the object query on the basis of, at least, the technique of DETR.

According to the present embodiment described above, in object detection targeting both known objects and unknown objects, learning for objectness estimation is stopped at the stage of the initial layer of the transformer decoder, only learning for class estimation and learning for object region detection are performed in the subsequent layers, and the object queries include queries selected by query selection to capture known objects and learnable queries initialized to capture both known objects and unknown objects. That is, this makes it possible to capture the features of objects from the initial layer of a transformer decoder while preventing conflict between learning for objectness estimation and learning for class estimation from arising, thereby improving the accuracy of object detection.

The above-described embodiment can be represented as follows.

A driving assistance device including:
a storage medium having computer-readable instructions stored therein; and
a processor connected to the storage medium,
wherein the processor is configured to execute the computer-readable instructions, to thereby
convert an input image into a high-dimensional vector,
determine whether a query set in the input image is an object on the basis of the high-dimensional vector,
detect a region of the object on the basis of the high-dimensional vector,
detect a type of the object on the basis of the high-dimensional vector,
detect an object by processing the high-dimensional vector, and
detect the object on the basis of a result of detection of the region of the object and the type of the object based on a high-dimensional vector obtained by processing the high-dimensional vector multiple times, and a result of determination of whether it is the object based on a high-dimensional vector obtained by processing the high-dimensional vector earlier than the multiple times.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An object detection device comprising:
a storage medium having computer-readable instructions stored therein: and
a processor connected to the storage medium,
wherein the processor executes the computer-readable instructions, to thereby
convert an input image into a high-dimensional vector,
determine whether a query set in the input image is an object on the basis of the high-dimensional vector,
detect a region of the object on the basis of the high-dimensional vector,
detect a type of the object on the basis of the high-dimensional vector, and
detect an object by processing the high-dimensional vector, and
the processor detects the object on the basis of a result of detection of the region and the type based on a high-dimensional vector obtained by processing the high-dimensional vector multiple times and a result of the determination based on a high-dimensional vector obtained by processing the high-dimensional vector earlier than the multiple times.

2. The object detection device according to claim 1, wherein functional units for the conversion of the high-dimensional vector, the determination, the detection of the region, and the detection of the type are obtained by training a deep learning model having a self-attention mechanism.

3. The object detection device according to claim 2, wherein the deep learning model is a transformer model, and
the processor detects the object on the basis of a result of detection of the region and the type based on a high-dimensional vector obtained by processing the high-dimensional vector multiple times in each layer of a decoder of the transformer model, and a result of the determination based on a high-dimensional vector obtained by processing the high-dimensional vector earlier than the multiple times in each layer of the decoder.

4. The object detection device according to claim 1, wherein the processor calculates a first probability value indicating whether the query is an object,
the processor calculates a second probability value indicating a type of the query, and
the processor detects the object on the basis of the first probability value and the second probability value.

5. The object detection device according to claim 1, wherein the query includes a first query selected from a plurality of the high-dimensional vectors and an initialized second query, and
the processor detects the object for each of the first query and the second query.

6. The object detection device according to claim 5, wherein the first query is selected to be distributed over known objects in the input image, and the second query is set to be distributed across the entire input image and is trained to be distributed over both known objects and unknown objects.

7. An object detection method comprising causing a computer to:
convert an input image into a high-dimensional vector;
determine whether a query set in the input image is an object on the basis of the high-dimensional vector;
detect a region of the object on the basis of the high-dimensional vector;
detect a type of the object on the basis of the high-dimensional vector;
detect an object by processing the high-dimensional vector; and
detect the object on the basis of a result of detection of the region of the object and the type of the object based on a high-dimensional vector obtained by processing the high-dimensional vector multiple times, and a result of determination of whether it is the object based on a high-dimensional vector obtained by processing the high-dimensional vector earlier than the multiple times.

8. A computer readable non-transitory storage medium having a program stored therein, the program causing a computer to:
convert an input image into a high-dimensional vector;
determine whether a query set in the input image is an object on the basis of the high-dimensional vector;
detect a region of the object on the basis of the high-dimensional vector;
detect a type of the object on the basis of the high-dimensional vector;
detect an object by processing the high-dimensional vector; and
detect the object on the basis of a result of detection of the region of the object and the type of the object based on a high-dimensional vector obtained by processing the high-dimensional vector multiple times, and a result of determination of whether it is the object based on a high-dimensional vector obtained by processing the high-dimensional vector earlier than the multiple times.
